(19) United States
(12) Patent Application Publication
(10) Pub. No.: US 2024/0323060 A1
(43) Pub. Date: Sep. 26, 2024

(54) FREQUENCY MULTIPLEXED ACTIVE TAPS

(71) Applicant: Shaun Joseph CUNNINGHAM, New South Wales (AU)

(72) Inventor: Shaun Joseph CUNNINGHAM, New South Wales (AU)

(21) Appl. No.: 18/576,223

(22) PCT Filed: Jul. 4, 2022
(86) PCT No.: PCT/AU2022/050694

§ 371 Date: Jan. 3, 2024

(30) Foreign Application Priority Data
Jul. 3, 2021 (AU) 2021902022

(51) Int. Cl. H04L 25/02; H04J 1/10; H04L 12/28

(52) U.S. Cl. CPC H04L 25/0264; H04J 1/10; H04L 12/2801

(57) ABSTRACT

The present application relates generally to signal distribution networks carrying signals on coaxial cables where frequency multiplexing techniques are utilised to provide greater data transmission bandwidths. In one aspect, the application provides a tap for use in a coaxial distribution network, the tap including: an upstream port, a downstream port, and at least one drop port, and a number of signal paths coupled between the upstream port and the downstream port, each signal path having a passband frequency range which is not common to any other signal path.

### RELATED APPLICATIONS

This application claims the priority of Australian Provisional Patent Application No. 2021902022 in the name of Shaun Cunningham, which was filed on 3 Jul. 2021, entitled “Frequency Multiplexed Active Tap” and the specification thereof is incorporated herein by reference in its entirety and for all purposes.

### FIELD OF THE INVENTION

The present invention relates generally to signal distribution networks carrying signals on coaxial cables and, in particular, to the implementation of frequency multiplexing techniques in such networks.

The invention has been developed primarily for use in Hybrid Fibre Coaxial (HFC) networks using DOCSIS modulation schemes and will be described hereinafter with reference to this application. However, it will be appreciated that the invention is not limited to this field of use, and may provide benefits in other network types using other modulation schemes.

### BACKGROUND OF THE INVENTION

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

As the world's demand for entertainment and information content increases, new means of distributing this content are being developed. Cable TV (CATV) networks have been deployed since the 1980's and are an example of a telecommunication network that was built to offer subscribers a significantly increased range of content. Coaxial cable has traditionally been used for such distribution networks because it has relatively low cost and because it simplifies connection to network devices and customers premises. Network coaxial cables consist of outer plastic jacket, a conductive outer sheath, a low loss insulator and central conductor. Although original CATV networks were entirely made from coaxial cables, modern networks often employ a so-called Hybrid Fibre Coax (HFC) structure where connectivity is provided using optical fibres from the core network to Nodes where data is converted to electrical signals and conveyed to customer's premises using coaxial cables.

Although the content capacity of CATV networks has previously met subscriber's requirements, there is a growing demand for subscriber customised content, for example in the form of streaming video on demand and other internet related sources of information or entertainment content. As a result, network operators are under increased pressure to make use of the full bandwidth capacities of their networks and/or to increase their network bandwidth capacities by upgrading network elements.

FIG. 1 provides a block diagram of a conventional HFC network architecture. Signals are conveyed to and from a ‘Head End’ installation 100 using optical fibres 101 or satellite links. These links carry data at many gigabits per second and provide connectivity to the internet and other information service providers such as cable TV operators. Signals are then conveyed from the Head End to ‘Nodes’ 102 which are located close to groups of customers. At the Nodes, optical signals are then converted to and from electrical signals 103 which propagates through coaxial cables to and from customers.

Unlike fibre transmission mediums, coaxial cables are relatively lossy which means that electrical signals quickly degrade when travelling only modest distances through cable. To combat this degradation, network designers install amplifying devices along the cable route to boost signals and overcome degradation due to loss. For example, amplifiers may be installed every 400 metres along the cable path to amplify signals travelling both ‘downstream’ toward the subscribers and ‘upstream’ toward the Head End, i.e., bi-directionally.

In the portion of the coaxial network closest to the Node, coaxial amplifiers conventionally carry bidirectional signals between two signal ports without any splitting or combining of the signal path. These are generally referred to as ‘Trunk’ amplifiers 104.

When the signal path nears the intended subscriber group, it is advantageous for amplifying devices to not only amplify signal levels, but also to assist in the geographic distribution of these signals. Therefore, amplifiers may include signal splitting and combining devices which facilitate a tree-like signal distribution network architecture. These amplifiers split downstream signals and send them to multiple subscriber groups and combine upstream signals from multiple subscriber groups and send them to the Head End. These splitting and combing amplifiers are generally referred to as ‘Bridging Amplifiers’ 105 or colloquially as ‘Bridgers’ and typically have a 1:2 or 1:3 split/combine ratio.

Another class of amplifying device is called a ‘Line Extender’ 106. This amplifier type is similar to a Trunk Amplifier, except it is optimised for use closer to the network customer. For example, the gain and/or signal levels produced or received by these Line Extenders may be significantly less than those conveyed by Trunk Amplifiers.

In the final section of a HFC network, ‘Taps’ 107 are installed on the coaxial cable as it passes a customer's premises and a drop cable 108 is run from the tap into the customer's premises. This connection usually terminates inside the premises at a network element such as a modem 109 which decodes network signals and provides customers with a local area network to which they can connect devices such as TVs or computers. A modem is an example of what is referred to generally as Customer's Premises Equipment (CPE).

Taps are conventionally passive devices which couple signals from a ‘Through’ connection to a number of drop cables which allow customers to connect to the network. Conventional taps rely on ferrite-based transformers to couple signals at the appropriate levels to and from drop cables. Conventional taps do not provide amplification for any signals as they pass through the tap. The advantage of this type of network element is that they are relatively low cost and are insensitive to spectrum allocation and usage within the network bandwidth. The disadvantage is that they have limited transmission bandwidth and are excessively lossy at high frequencies which prevents the overall network being significantly upgraded.

In conventional networks, signals sent from the customer's premises upstream to the Node traverse the same path as downstream signals, but occupy a different portion of the network spectrum.

It is advantageous for network operators to rely on agreed standards for signal transmission on coaxial network to maximise equipment interoperability when sourced from multiple vendors. The most common standard used in HFC networks is the Data Over Cable Service Interface Specifications, known as DOCSIS. This standard specifies physical layer signal transmission requirements such as power spectral density, spectrum allocations (e.g., channelisation), modulation schemes and error protection mechanisms, as well as upper layer protocols.

Most conventional HFC networks currently use DOCSIS version 3.0 and are evolving to use DOCSIS 3.1. In 2019, the DOCSIS 4.0 standard was released which is intended to stimulate device and component manufacturers to design devices and equipment to enable high performance DOCSIS 4.0 networks to be built over the next decade.

DOCSIS 3.0 networks typically have an upper frequency limit of 750-860 MHz whereas DOCSIS 3.1 networks have a typical upper frequency limit of 1-1.2 GHz. Recent trends indicate that DOCSIS 4.0 networks will be built with an upper frequency limit of 1.8 GHz.

FIG. 2a shows an example of one common DOCSIS 3.0 frequency allocation where upstream band 201 spans 5 to 65 MHz and downstream band 202 spans 85 to 860 MHz. FIG. 2b shows an example of one common DOCSIS 3.1 frequency allocation where upstream band 203 spans 5 to 204 MHz and downstream band 204 spans 258 to 1200 MHz. Each example includes a dead band between upstream and downstream spectrums. In the following description the nominated frequencies are indicative only and are not meant to restrict the scope of the invention. For simplicity, dead bands are omitted from the following description because they are not generally relevant to the present invention.

FIG. 3 shows the architecture of a conventional passive tap 300 comprising and upstream port 301, a downstream port 302 and a plurality of N drop ports 303 coupled to drop cables 304 which lead to customer's premises equipment 305. The N drop ports of the tap are coupled to N ports of an N-way power divider/combiner 306 which in turn is coupled to the main network cable using a directional coupler 307. N is typically 2, 4 or 8. Signals flow through the tap bi-directionally between each port. Each signal path has sufficient bandwidth to convey the entire bandwidth of upstream plus downstream channels simultaneously. For example, to carry the spectrum shown in FIG. 2a, each signal path in the tap would carry signals in the range 5 to 860 MHz.

Network operators are continually striving to provide increased data rates to customers. This means that networks need to be upgraded to provide wider bandwidths, either by increasing modulation complexity or by extending the upper frequency limit of the network. However, it is very costly to do this because network equipment and cabling may need to be replaced. Instead, it is attractive to leave cabling in place and upgrade network equipment with only minimal disruption to the network. This creates a demand for techniques which can extend network bandwidth while using as much existing network infrastructure as possible.

Although Standards are useful in maximising interoperability of network equipment, Standard evolution is slow and incremental and is generally not able to cope with the growth in demands for network bandwidth. For example, network operators currently experience a 30% increase in network traffic each year, so in 5 years network capacity will need to increase almost by a factor of 4. This means that previous standards-based network upgrade philosophies cannot easily cope with increasing demand. Or, if new standards are adopted quickly and are fully implemented to provide the extra capacity needed, the cost of upgrading the network will be excessive.

DOCSIS standards have been developed by an industry consortium composed of network operators, equipment manufacturers and device developers. DOCSIS standards have evolved in a direction which tends to disadvantage network operators and favour device and equipment vendors, i.e., increased network performance generally comes at the cost of installing new network hardware. For example, DOCSIS 3.1 and 4.0 networks potentially require all amplifiers, customer modems and network taps to be replaced at significant cost. This upgrade generates significant revenue for device and equipment vendors who are motivated to push standard evolution in this direction.

Accordingly, the inventor has realised that there is a need for a new means of upgrading the operational bandwidth of coaxial networks to provide significantly increased capacity while preserving as much existing network infrastructure as possible in order to lower upgrade cost.

The present invention provides specific details of the composition and use of active taps comprising mixers, oscillators, filters, amplifiers, switches and frequency multiplexing architectures which allow network bandwidth to be increased with minimal changes to the network. For convenience, this new type of tap is referred to herein as a Frequency Multiplexed Active Tap, or FMA Tap.

In order to deploy FMA taps into an existing HFC network, several problems need to be addressed:
Because existing passive taps need to be replaced one-by-one, an FMA tap needs to operate in a ‘legacy mode’ so that existing network traffic is not disturbed while the network segment is being progressively upgraded to the new transmission standard. There is a need to find a way for this functionality to be implemented efficiently at minimum cost and to define the optimal way of controlling staged activation of the network remotely from a centralised site.
Because the widespread use of active taps creates a cascade of multiple amplifying devices, the reliability of the network is lowered because active devices are less reliable than passive devices. Accordingly, there is a need for a network architecture and tap design which provides the benefits of frequency multiplexed architectures, but lessens the impact of failures resulting from reliance on a larger number of active devices.
An objective of using frequency multiplexing in HFC networks is to maintain the use of existing customer premises modems, thereby avoiding modem replacement costs. This can be achieved by translating signals intended for a particular modem up to a higher frequency band when transmitted from the node-end of the network and translating these signals back down to baseband in the active tap which is connected to a particular group of modems. To perform this frequency division multiplexing, filters (diplexers) are needed. These filters require sharp out-of-band cut-off characteristics in order to allow other devices to use nearby frequency bands, thereby maximising spectrum utilisation. Filters with sharp cut-off characteristics are complex, costly and difficult to manufacture reliably. Accordingly, there is a need for a means of implementing frequency division multiplexing which increases spectrum utilisation and reduces the demands placed on filters.

The discussion throughout this specification comes about due to the realisation of the inventor and/or the identification of certain prior art problems by the inventor and, moreover, any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF THE INVENTION

It is therefore an object of the preferred embodiments described herein to overcome or alleviate at least one of the above noted drawbacks of conventional systems.

Accordingly, in one aspect, embodiments of the present invention provide a tap for use in a coaxial distribution network, the tap comprising:
an upstream port, a downstream port, and at least one drop port; and
a plurality of signal paths coupled between the upstream port and the downstream port, each signal path having a passband frequency range which is not common to any other signal path.

It is preferred that the plurality of signal paths comprises:
a unidirectional, high frequency signal path; and
a bidirectional, low frequency signal path.

It is preferred that the unidirectional, high frequency, signal path is a downstream path.

It is preferred that the plurality of signal paths comprises at least one diplexer.

When the tap comprises a unidirectional high frequency signal path, it is preferred that that path is coupled to the tap drop port using a directional coupler.

It is preferred that the high frequency signal path comprises an amplifier to amplify downstream signals.

It is preferred that the amplifier comprises an equaliser to provide different amplification at different frequencies.

It is preferred that the tap further comprise a computing device to control the characteristics of the equaliser.

It is preferred that the computing device is configurable to receive data from a remote site and to use that data to control the characteristics of the equaliser.

It is also preferred that the computing device controls the characteristics of the equaliser autonomously using a program stored in the computing device.

It is preferred that the tap further comprise:
a first mixer having an input port and an output port, the first mixer being configured to translate signals received at its input port into signals which are in a different frequency range at its output port; and
a first filter,
in which:
downstream signals are receivable by the tap at the upstream port; the downstream signals are coupled to the input of the first mixer; and
the output of the first mixer is coupled to the input of the first filter.

When the tap comprises a first mixer and a first filter, it is preferred that the tap further comprise, interposed between the outport port of the first filter and the drop port:
a second mixer having an input port and an output port, the second mixer being configured to translate signals received at its input port into signals which are in a different frequency range at its output port; and
a second filter,
in which:
signals from the output port of the first filter are receivable at the input port of the second mixer; and
signals from the output port of the second mixer are receivable at the input port of the second filter.

When the tap has only a first mixer and a first filter, it is preferred that the output of the first filter is coupled to the at least one drop port of the tap.

When the tap has both a first and a second mixer and a first and a second filter, it is preferred that the output of the second filter is coupled to the at least one drop port of the tap.

It is preferred that the downstream signals are coupled to the input of the first mixer by a directional coupler.

In the case of a tap which has only the first mixer and the first filter, it is preferred that, when the tap is coupled to a customer's premises equipment transceiver (CPE transceiver), the first filter has a passband frequency range which is within the frequency range of the CPE transceiver.

In the case of a tap which has both a first and a second mixer and a first and a second filter, it is preferred that, when the tap is coupled to a customer's premises equipment transceiver (CPE transceiver), the second filter has a passband frequency range which is within the frequency range of the CPE transceiver.

It is preferred that the first filter has a passband frequency range which selects a portion of the upper sideband signal which is produced by the first mixer.

When the tap has both a first and a second mixer and a first and a second filter, it is preferred that the second filter has a passband frequency range which is within the receiving frequency range of the CPE transceiver.

It is preferred that:
signals coupled between the upstream and downstream ports of the tap are conveyed by independent, high frequency and low frequency signal paths; and
the lowest frequency conveyed by the high frequency signal path is higher than the highest frequency able to be received by the CPE transceiver.

According to another aspect, embodiments of the present invention provide a coaxial distribution network comprising at least one tap as summarized above.

According to another aspect, embodiments of the present invention provide a coaxial distribution network coupled to a plurality of CPE transceivers, in which network:
each CPE transceiver has a downstream receiving bandwidth and an upstream transmission bandwidth;
downstream signals in the network are grouped into M channels, each channel having a frequency range which has substantially the same bandwidth as the CPE transceiver downstream receiving bandwidth;
upstream signals in the network are grouped into N channels, each channel having a frequency range which has substantially the same bandwidth as the CPE transceiver upstream transmission bandwidth; and
the group of N upstream channels occupies a lower frequency range than the frequency range of the group of M downstream channels; and
N and M are integers greater than or equal to two.

It is preferred that, in the network:
the M downstream channels are grouped together within a first frequency band;
the N upstream channels are grouped together within a second frequency band; and
the first frequency band is located at a higher frequency than the second frequency band.

It is preferred that the upstream and downstream channels can carry signals which utilise RF encoding and decoding schemes which are compatible with the decoding and encoding schemes of the CPE transceivers.

According to another aspect, embodiments of the present invention provide a method of changing a coaxial distribution network from one mode of operation to at least one different mode of operation, the method comprising the steps of:
removing an existing tap from the network;
installing a tap which comprises at least one switch which can select among the available modes of operation;
progressively removing and replacing all of the taps on the network in the same manner; and
then sending a signal to each tap in the network which causes the taps to switch from one mode of operation to another mode of operation.

According to this aspect of the invention, it is preferred that at least one of the modes of operation provides increased aggregate network signal bandwidth relative to at least one of the other modes of operation.

According to another aspect, embodiments of the present invention provide a tap which further comprises a plurality of switches which are configurable to couple downstream signals which are conveyed by a low frequency bidirectional signal path to an amplifier which increases the amplitude of downstream signals passing from the bidirectional signal path to at least one drop port.

These and other features, aspects and advantages of the present invention will become better understood with reference to the following drawings, description and claims. Accordingly, further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 provides a summary of conventional HFC network element types and network topology,

FIGS. 2a and 2b provide examples of allocation of upstream and downstream signal bands in conventional DOCSIS networks,

FIG. 3 shows the functional composition of a conventional passive tap,

FIG. 4a provides a block diagram of a preferred embodiment of the present invention comprising upper and lower frequency signal paths and frequency multiplexing devices used to increase the bandwidth available for downstream signals,

FIG. 4b shows an example of one possible allocation of upstream and downstream signal bands according to a preferred embodiment of the present invention.

FIG. 4c shows and example of one possible demodulation process according to a preferred embodiment of the present invention,

FIG. 5 shows possible frequency translations resulting from demodulation of downstream signal spectrums according to preferred embodiments of the present invention,

FIG. 6a provides a block diagram of a preferred embodiment of the present invention comprising a two stage downstream signal demodulator where a first stage converts the downstream signal to a higher frequency range,

FIG. 6b provides an example of the spectrum plan of a preferred embodiment of the present invention comprising a two stage downstream signal demodulation process,

FIG. 7a provides a block diagram of a preferred embodiment of the present invention comprising a two stage downstream signal demodulator where a first stage converts a portion of the downstream signal to a higher frequency range,

FIG. 7b provides an example of the spectrum plan of a preferred embodiment of the present invention comprising a two stage downstream signal demodulation process where the passband of the filter used to couple the downstream signal into the receiving band of a modem is coincident with the uppermost frequency band of the modulated downstream signal,

FIG. 8a provides a block diagram of a preferred embodiment of the present invention comprising an upstream signal modulator and selectable upstream filters,

FIG. 8b provides an example of the spectrum plan of a preferred embodiment of the present invention showing an upstream modulation process,

FIG. 9 shows an example of a preferred arrangement of upstream and downstream channels according to a preferred embodiment of the present invention,

FIG. 10 provides a block diagram of a preferred embodiment of the present invention showing a ‘fail safe’ bidirectional signal path between the downstream port and drop port of an FMA tap,

FIG. 11 provides a flowchart showing the steps involved in a method of upgrading a network to use FMA taps according to another embodiment of the present invention,

FIG. 12 provides a block diagram of one example of a preferred embodiment of the present invention comprising downstream amplifiers which overcome losses in customer's premises cabling.

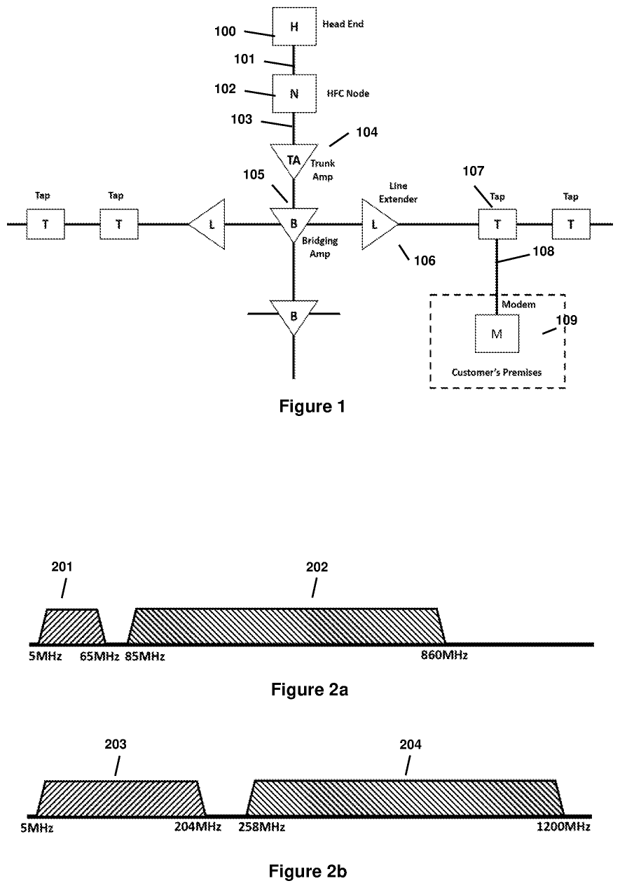

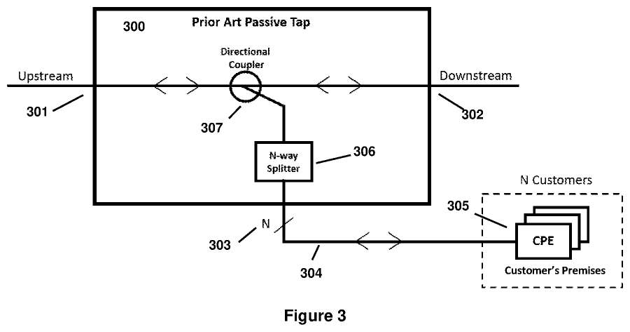

### DETAILED DESCRIPTION OF PREFERRED EMBODIMENTS OF THE INVENTION

### Definitions

Preferred embodiments of the present invention will now be described in relation to the drawings. Where possible, equivalent numbers have been used to identify the same element in each drawing or sub-drawing. Terms such as “top” and “bottom” are intended to aid description of the drawings as shown and are not meant to restrict the scope of the invention. Throughout this description, including the claims and abstract, and unless the contrary intention appears, the following definitions apply.
The term “coaxial distribution network” or “coaxial network” refers to a telecommunication network where information is conveyed to and from customer's premises using electrical signals carried on coaxial cables.
The term Hybrid Fibre Coax, abbreviated as HFC, means a coaxial network coupled to an optical fibre where subscribers access the network using electrical signals which are conveyed through the coaxial network to and from a Node.
The term “HFC Node” or “Node” means network equipment in an HFC network which converts signals between an optical format and an electrical format which is coupled to a coaxial distribution network.
The term “CPE” is used to mean Customer's Premises Equipment located within a customer's premises and connected to the coaxial network. A “modem”, which is used to transmit and receive signals to and from the coaxial network, is an example of one type of CPE.
The terms “modem” or “customer modem” each mean any device located within a customer's premises which converts signals carried by the coaxial network into a different electrical signal format.
The terms “upstream” and “downstream” each mean a signal propagation direction toward, and away from, an HFC Node, respectively.
The term “Port” means a signal interface provided by means of a coaxial connector.
The terms “upstream-facing port” and “upstream port” each mean a signal port for exchanging signals with the network node.
The term “downstream-facing port”, and “downstream port”, each mean a signal port for exchanging signals with equipment which is most distant from the network node.
The term “tap” means an HFC network device used to connect a group of 1 or more customers to the network and which comprises an upstream coaxial interface port, a downstream coaxial interface port, and a plurality of coaxial ‘drop’ ports which are used to connect CPE to the network.
The term “through” when referencing a signal path in a tap means signals coupled between the tap's upstream and downstream ports.
The term “mixer” means a nonlinear device which accepts 2 or more signals at frequencies F1, F2 etc and produces signals at frequencies which are sums and differences of multiples of F1 and F2 etc, e.g., F1+F2, 3*F1−2*F2 etc.
The term “transceiver” means an interface device which can both receive and transmit signals either sequentially or simultaneously.
The term “passband” of a device, circuit element or signal path means the frequency range in which signals pass through the device, circuit element or signal path, and outside of which signals passing through the device, circuit element or signal path are substantially attenuated.
The term “hard-line” refers generally to coaxial cables which pass customer's premises, which typically have a semi-rigid form, and which allow customers to connect to the network through taps coupled to the hard-line.

### DESCRIPTION

According to a first aspect, the present invention provides a frequency multiplexed active tap (“FMA-tap”) comprising an upstream port, a downstream port and a plurality of drop ports. Signal flow through the tap is controlled by separating signals into different frequency bands and selectively applying amplification and/or frequency translation to signals present at each port.

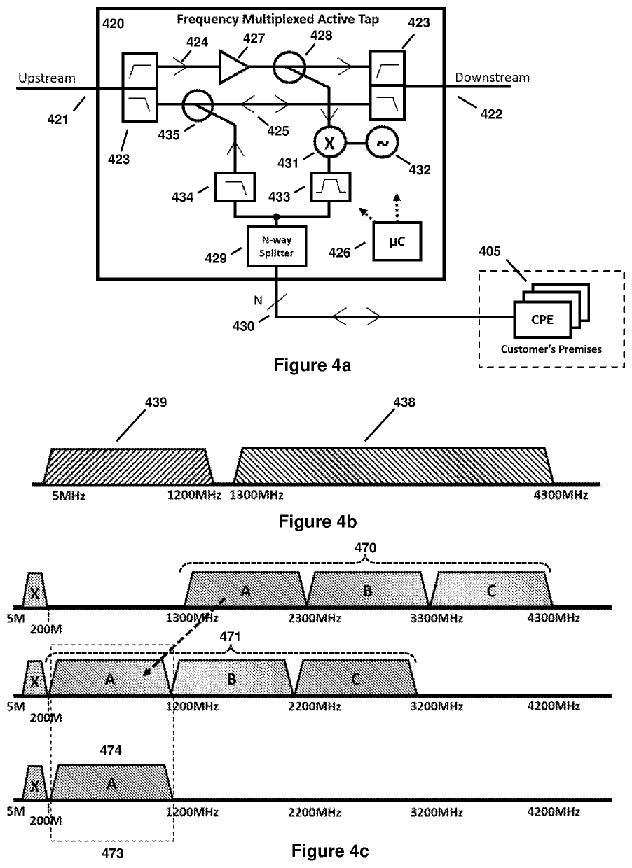

### The Embodiments of FIG. 4

FIG. 4a shows the basic architecture of an FMA-tap according to one preferred embodiment of the present invention. Unlike a conventional passive tap, the FMA-tap comprises filters 423 at the upstream port 421 and downstream port 422 which create a number of independent signal paths between each port. One preferred embodiment of this type of filter is known as a diplexer where two signal paths are created. Each diplexer comprises a high pass filter which passes signals above a first specified cut-off frequency along an upper frequency signal path 424, and one low pass filter which passes signals below a second cut off frequency along a lower frequency signal path 425. These first and second cut-off frequencies may be the same frequency or different frequencies in order to provide improved separation between the upper and lower frequency bands. The use of any type of filter structure which separates the signal bandwidth present at each FMA-tap port into multiple separate frequency bands is within the scope of the present invention.

For example, diplexers may split the signal at the upstream port of the FMA-tap into a lower band less than 1.2 GHz and an upper band greater than 1.2 GHz. Alternatively, the upper frequency band may be greater than 1.3 GHz in order to provide a 100 MHz ‘dead-band’ between upper and lower frequency bands, thereby providing improved signal separation between the bands, if this is advantageous. Although this separation will improve band separation and reduce signal crosstalk between the bands, it will come at the cost of leaving a portion of the overall bandwidth unutilised. The choice of dead-band width is a matter for network operators to decide. FIG. 4b shows one preferred example of upper 438 and lower 439 signals bands produced by diplexers 423.

According to a preferred embodiment of the present invention, and unlike signal flow in conventional taps, a plurality of possible signal paths are provided between the tap upstream, downstream and drop ports, where each signal path has a separate passband frequency and where the directionality of some of the signal paths differs. For example, one embodiment of the present invention comprises two signal paths: an upper frequency path 424 which is exclusively allocated to downstream signals and which is unidirectional, and a lower frequency signal path 425 which is bidirectional, carrying both downstream and upstream signals.

The advantage of this signal flow partitioning is:
Network data bandwidth can be expanded to utilise higher portions of the available network bandwidth than is used in conventional networks, for example in the frequency range 1.2 GHz to approximately 4 GHZ;
Amplification can be selectively provided for downstream signals in the upper frequency band to overcome cable attenuation and other losses which are more severe at higher frequencies;
The ratio of the uppermost and lowermost frequencies relative to the centre frequency of the upper frequency band is relatively small, unlike the same ratio for the lower frequency band. This means that the upper frequency band is relatively ‘narrow’ which simplifies the design of high frequency devices such as amplifiers and directional couplers; and,
Unlike the upper frequency band which contains amplifiers, the lower frequency band is passive, i.e. contains no amplifying devices, and therefore is able to provide a bidirectional, fail-safe signal path.

As shown in FIG. 4, the upper frequency signal path of the FMA-Tap 424 is preferably amplified by amplifier 427 comprising an equalising network which provides increased gain at the high frequency end of the band, e.g., at 4 GHZ, compared to the low frequency end of the band, e.g., at 1.2 GHZ. This equaliser is designed to compensate for frequency dependent attenuation of the downstream signal caused by cable loss, and any other causes of insertion loss. This equaliser is preferably electronically variable and controlled by a computing device such as a microcontroller 426 located within the tap. Preferably this computing device 426 communicates with a centralised computer at a remote location. This centralised computer collects signal amplitude data from the entire network and calculates the appropriate gain and equalisation settings required for the equalising amplifier in each individual FMA-tap. At times, the equaliser gain setting may also be controlled autonomously by the tap's microcontroller, for example, when communication with the remote computer is lost or when the network needs to adopt a default setting. Amplifier equalisation settings which are adjusted using plug-in modules or mechanical switches are also within the scope of the present invention. For example, plug in modules may comprise fixed filtering or attenuation circuits.

According to a preferred embodiment of the present invention, the FMA-Tap comprises a directional coupler 428 which couples an attenuated version of the downstream signal contained in the upper frequency band to N FMA-Tap drop ports 430. For example, N may be 2, 4 or 8. The directional coupler 428 provides increased sensitivity to wanted downstream signals and isolation from in-band upstream noise or interference. The specific directional coupler used by the FMA-Tap determines what percentage of the downstream power is extracted from the received downstream signal and divided amongst the N drop ports. Typical attenuation provided by directional couplers is in the range 6 to 20 dB. Although the directional coupler is shown in FIG. 4a after amplifier/equaliser 427, it can be located either before or after the amplifier/equaliser 427 within the scope of the present invention.

From an additional perspective the present invention provides an FMA-Tap comprising a mixer, oscillator and filter where:
Said mixer and oscillator act together to produce a frequency-translated version of a downstream signal received by said tap,
A portion of said frequency-translated downstream signal falls within the passband of said filter,
The signal passing trough said filter is coupled to the drop ports of said tap.

Referring again to FIG. 4, a preferred embodiment of the present invention comprises mixer 431 which is coupled to an upper frequency band directional coupler 428, and an oscillator 432. The mixer and oscillator translate the signal provided by directional coupler 428 to a different range of frequencies. Filter 433 selects a portion of the translated spectrum and couples this to power splitter 429 and then to tap drop ports 430.

FIG. 4c shows an example of a downstream signal spectrum 470 received by an FMA-tap according to the present invention. A signal with this spectral composition, but with reduced amplitude, is produced by directional coupler 428 and coupled to mixer 431. Spectrum 470 contains multiple downstream channels, each carrying different information content. Information contained within each channel is preferably encoded in a DOCSIS format. In the example shown in FIG. 4c there are three channels which are labelled A, B and C for descriptive purposes. Preferably, each of these channels has the same bandwidth as the receive bandwidth of customer modems which are coupled to the tap drop ports. For example, if customer modems 405 are able to receive downstream signals in the range 200 MHz to 1200 MHZ (a total bandwidth of 1000 MHz), preferably each of the downstream channels A, B and C has this same bandwidth, i.e., 1000 MHz.

In the example shown in FIG. 4c, downstream spectrum 470 is translated downwards in frequency by mixer 431 and oscillator 432 to produce spectrum 471. The spectrum shown would appear as the lower sideband signal produced by mixer 431 if oscillator 432 had a frequency of 1100 MHz, and if channel A existed between 1300 and 2300 MHz. In this example, filter 433 would have a passband from 200 to 1200 MHz, shown as dotted box 473. This filter rejects signal components outside of this band and produces spectrum 474 which is compatible with the receive band requirements of the customer modems 405 coupled to the tap drop port. Filter 433 also rejects upper sideband signals produced by mixer 431. In this way the FMA-tap is able to access downstream signals outside the conventional bandwidth of the network, thereby increasing available data bandwidth.

In the example shown in FIG. 4, the FMA-Tap translates and selects a range of frequencies equivalent to the full downstream receive bandwidth of a customer's modem. However, an FMA-Tap which translates and selects only a portion of a modem's receiving bandwidth is also within the scope of the present invention.

According to the present invention, downstream filter 433 is preferably coupled to another filter 434, forming a diplexer. This diplexer combines the downstream signal with upstream signals produced by customer modems connected to the FMA-Tap. The upstream signals are preferably coupled to a directional coupler 435 which injects these signals onto the upstream traffic signal path.

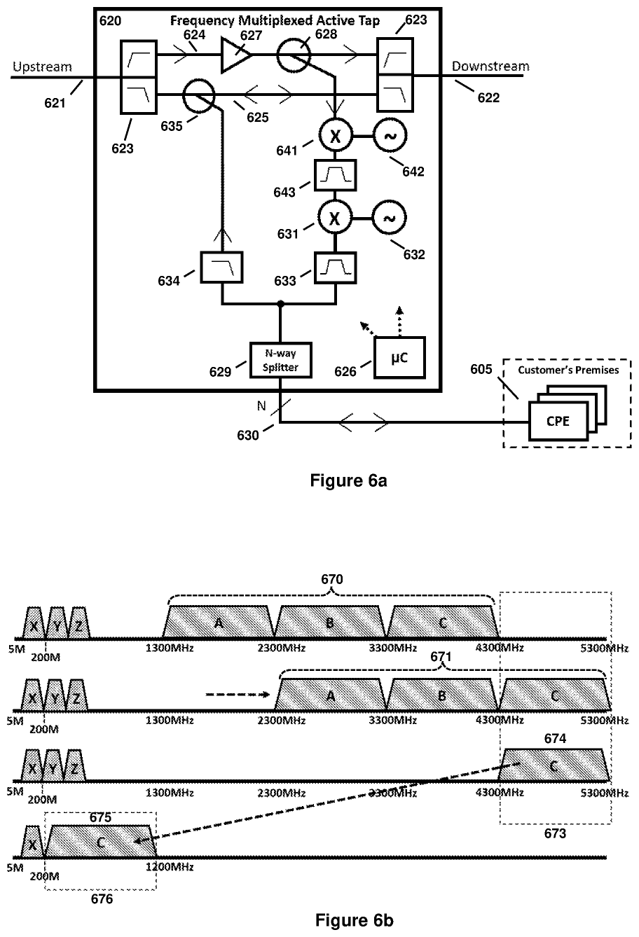

### The Embodiments of FIG. 6

From another perspective, the present invention provides a frequency multiplexed active tap comprising an up-converting mixer.

FIG. 6a provides a diagrammatic representation of a preferred embodiment of the present invention comprising a two stage frequency translator where:
the first stage uses a mixer and oscillator to translate the received downstream signal spectrum up to a higher frequency range in the form of an upper sideband produced by the mixer,
a filter extracts a portion of the upper sideband spectrum, and
a second mixer and oscillator translate the filtered portion of the upper sideband spectrum down to a frequency range which falls within the receiving bandwidth of a customer modem.

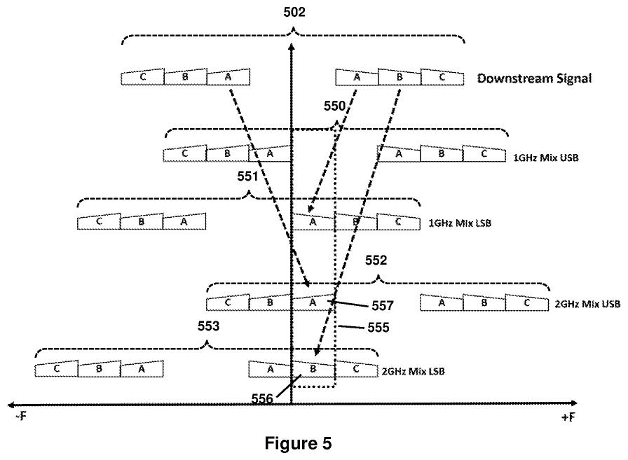

FIG. 5 shows extended details the frequency translation and selection process described in FIG. 4. This process provides increased network bandwidth by translating portions of the downstream signal spectrum downwards into the receiving band of customer modems. For example, if downstream signal 502 is translated by 1 GHz, upper sideband 550 and lower sideband 551 versions of the signal are produced. Because the frequency translation is relatively small, only one portion of signal 502 is mapped into the receiving band of the customer modem, shown as dotted box 555. In this case channel A is mapped into this band. The translated version of the image frequencies of each sideband, i.e., those with apparent negative frequencies, do not fall into the modem bandwidth 555.

However, when the downstream signal is translated by 2 GHZ, and upper sideband 552 and lower sideband 553 are produced, the image frequency of channel A 557 in upper sideband 552 falls within the modem receive band 555, as does channel B 556 of lower sideband 553. When these different signals overlap, the downstream signal appearing in the modem receive frequency band 555 will be corrupted.

The preferred embodiment of present invention shown in FIG. 6 overcomes this difficulty by first mixing the downstream signal received by the FMA-tap upwards to a higher frequency. When this happens, the image frequency components of the signal are translated down in frequency, causing the upper and lower signal sidebands to move away from each other, thereby preventing overlap and signal corruption in the modem's receiving band. This solution is particularly valuable in extended spectrum HFC applications because the ultra-wide bandwidth of downstream signals makes avoiding sideband conflicts difficult.

Referring to FIG. 6a, a preferred embodiment of the present invention comprises an FMA-tap 620 where the signal path through the tap is divided into a unidirectional upper frequency signal path 624 and a bidirectional lower frequency signal path 625. The downstream signal spectrum is divided into a number of independent bands (channels), for example labelled as A, B and C 670 in FIG. 6b. Three bands are shown in this example, but the invention is not restricted to this number of bands, or to the specific directionality shown for the signal paths. Each frequency band A-C represents an alternative downstream channel which can be multiplexed down to the receiving band of a customer modem 605. Preferably each of these channels contains a DOCSIS modulated signal which can be decoded by a conventional modem.

In the example shown in FIGS. 6a and 6b, downstream channels A, B and C have bandwidths of 1 GHz which is the same as the receiving bandwidth of the customer modems coupled to the tap. Channel A spans 1300-2300 MHz, channel B spans 2300-3300 MHz and channel C spans 3300-4300 MHz. The pass band of filter 643, shown as dotted box 673, is chosen to be 4300-5300 MHz. When oscillator 642 is set to 1 GHz, channel C is translated into the passband of filter 643 and spectrum 674 is produced at the filter output.

According to a preferred embodiment, the present invention comprises a first mixer 641, first oscillator 642 and first filter 643. Mixer 641 and oscillator 642 generate frequency-translated versions of the downstream signal 670 as upper and lower sideband signals at the output of mixer 641. The upper sideband of the translated signal 671 is shown in FIG. 6b. Filter 643 with passband 673 selects a portion of the upper sideband signal 671 to produce selected frequency band 674.

According to the present invention, a second oscillator 632 and a second mixer 631 are then used to produce upper and lower sidebands of selected spectrum 674, and filter 633 is used to select a portion of the lower sideband which matches the receive bandwidth of the customer modem coupled to the tap 675. Therefore, in the above example, the frequency of the second oscillator 632 would be 4100 MHz which would produce baseband spectrum 675 in the frequency range 200-1200 MHz as the lower sideband signal generated by mixer 631. Filter 633 preferably forms part of a filtering structure such as a diplexer which allows both upstream and downstream signals to be coupled to the intended modems through power splitter 629 and tap drop ports 630.

According to the present invention, a different downstream channel can be selected and provided to customer modems by changing the frequency of first oscillator 642. In the above example, if first oscillator 642 is set to 2 GHZ, channel B will be coupled through to the receive band of modems connected to tap 620.

The present invention not only provides customers with significantly increased overall data bandwidth, but also allows network operators to dynamically reconfigure allocation of downstream channels to meet changing customer needs. This can simply be achieved by changing the frequency of oscillator 642. This oscillator frequency is preferably selected electronically using a microcontroller 626 which is coupled to oscillator 642, or is configurable using mechanical switches or plug-in modules. In the case where the oscillator frequency is selected using a microcontroller, configuration data for the oscillator is preferably downloaded to the microcontroller over the coaxial network using a signal path from a remote site. This allows the network operator to dynamically change the configuration of the overall network from this remote site to meet customer needs.

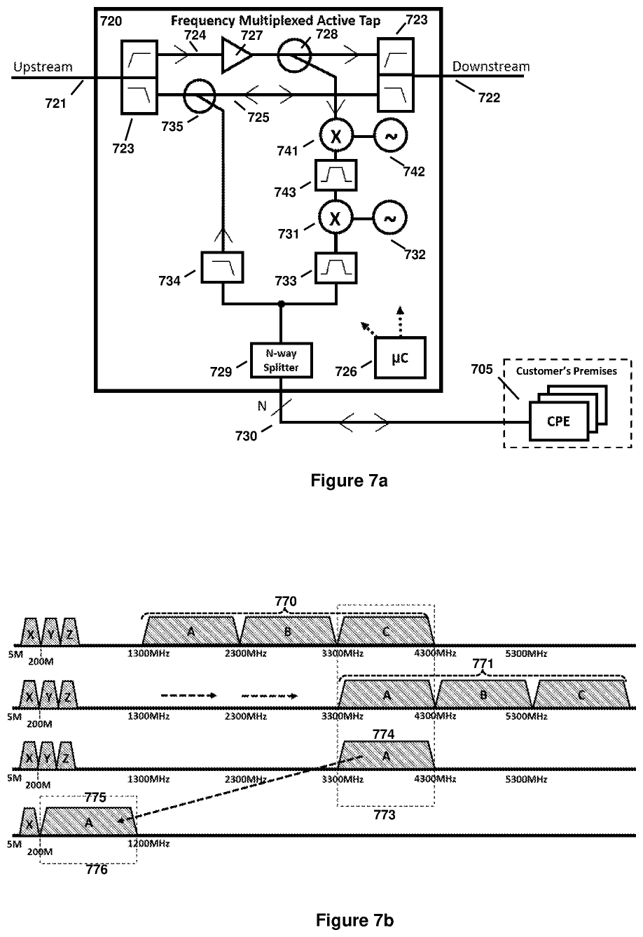

### The Embodiments of FIG. 7

An alternative embodiment of the present invention is shown in FIGS. 7a and 7b. In this case, the passband 773 of first filter 743 (corresponding to filter 643 above) is aligned to the highest downstream signal band (channel C) such that when oscillator 742 and mixer 741 are disabled (e.g., by applying DC current to the oscillator interface of mixer 741) or are bypassed, the highest downstream signal band (channel C) passes through to second mixer 731 without any frequency translation. This alternative allows the operating frequency range of first oscillator 742, first mixer 741 and the passband of filter 743 to be lowered in frequency, thereby reducing system complexity and costs which are generally higher at increased frequencies.

The example of FIG. 7b shows spectrum 771 which is produced by mixer 741 when oscillator 742 is set to 2 GHz. In this case, channel A falls within the passband 773 of filter 743 and is translated down into the receive bandwidth of customer modems coupled to the tap.

Preferably bandwidths of each channel A-C are matched to the receiving bandwidth of the customer modem, which simplifies the modularity of the frequency translation process. These channels preferably contain DOCSIS encoded signals which are able to be decoded by existing customer modems. The frequencies referenced in the above examples and are not intended to restrict the scope of the invention.

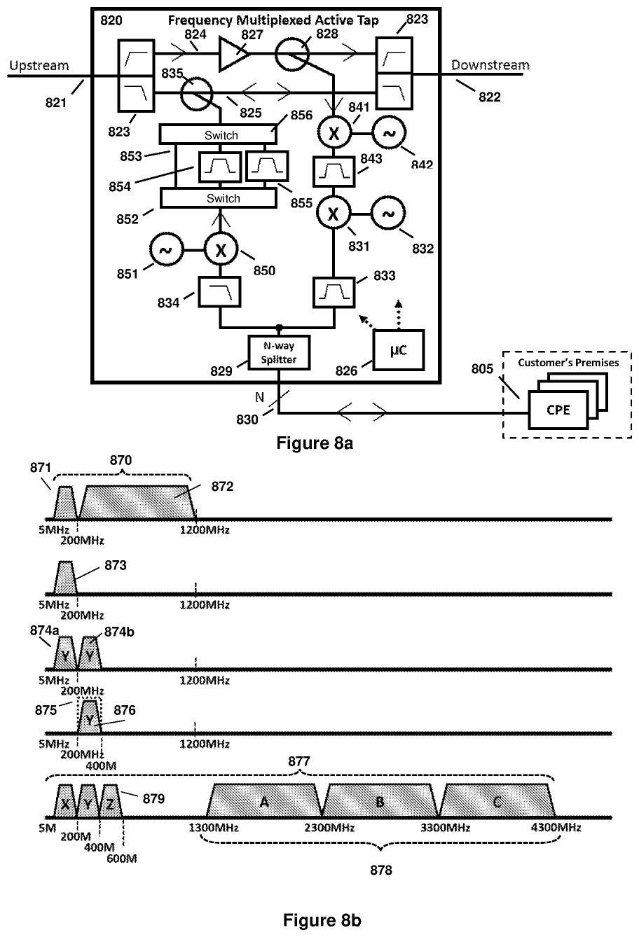

### The Embodiments of FIG. 8

From another perspective, the present invention provides a frequency multiplexed active tap comprising a modulator which translates upstream signals from customer modems to one of a plurality of possible upstream frequency bands.

FIGS. 8a and 8b show a preferred embodiment of the present invention comprising:
A first upstream filter which accepts only upstream signals sent by customer modems coupled to the tap,
A mixer which accepts said upstream signals passed through said first upstream filter,
A programmable oscillator coupled to said mixer, and
One or more switches coupled to the output of said mixer which select either:
   a second filter whose passband has the same bandwidth as said first filter and which is able to pass signals in the upper sideband of the signal spectrum produced by said mixer, or
   a signal path which does not include a filter.

The FMA tap 820 shown in FIGS. 8a and 8b receives upstream signals 871 from N customer modems 805 coupled to drop port 830 and combines these signals using an N-way power splitter/combiner 829. The combined upstream spectrum 871, together with downstream spectrum 872 forms the overall signal spectrum 870 which is representative of signals flowing at tap drop port 830.

The combined upstream signal 871 signal is coupled to an upstream filter 834 which has a passband matching the transmit band characteristics of modems 805. For example, this bandwidth might be 5-200 MHz. The output of filter 834 comprises only upstream signals 873 and these are coupled to mixer 850 which is also coupled to oscillator 851.

Mixer 850 either generates a frequency-translated version of the combined upstream signal in the form of an upper sideband 874b and a lower sideband 874a, or is disabled or bypassed to leave the spectrum of the upstream signal unchanged 873. One preferred way of disabling mixer 850 is to disable oscillator 851 and apply a DC current to the oscillator interface of mixer 850.

The frequency of oscillator 851 is programmable using a computing device such as microcontroller 826 contained within the tap. The frequency settings for this oscillator are preferably sent to computing device 826 over the network from a remote location, thereby allowing the frequency translation performed by mixer 850 to be varied according to changing network requirements.

For example, if an upstream signal arriving at the tap drop port spans 5-200 MHz and oscillator 851 was set to 200 MHz, mixer 850 would produce lower sideband 874a from 0-195 MHz and upper sideband 874b from 205-400 MHz. Similarly, by setting oscillator 851 to 400 MHz, the upper sideband 874b of the combined upstream signal can be translated to 405-600 MHz.

The objective of this frequency translation is to move the combined upstream transmission from modems coupled to the tap to a higher frequency band so that additional upstream bandwidth is provided to the HFC network.

Before the translated signals can be inserted into the network, lower sideband 874a must be removed because it exists in a frequency band occupied by transmission from other modems. Although this can simply be achieved using a filter, the passband of the filter needs to change to match the lower sideband frequency range produced by mixer 850. Because additional network bandwidth would typically be added in modular channels, it is convenient to implement the required variable filters as modular fixed frequency filters which are selected according to the programmed frequency of oscillator 851.

FIG. 8a shows an example of a preferred embodiment of the present invention comprising switches 852 and 856 which couple the output of mixer 850 to directional coupler 835 via one of three paths: a direct path without filter 853, a first filtered path through filter 854 and a second filtered path through filter 855. Although three paths are shown in FIG. 8a, the present invention is not restricted to this number of paths and the actual number used will be determined by the amount of upstream bandwidth available in the network and the transmission bandwidth of the modems coupled to the tap. For example, if 600 MHz of spectrum was allocated by the network operator for upstream transmission and modems transmitted in a band between 5-100 MHz, 6 paths and 5 filters may be used.

Direct path 853 is chosen when no frequency translation is performed by mixer 850 and lower sideband filtering is not required. If modems transmit in the band 5-200 MHZ, first filter 854 would preferably have a passband of approximately 200-400 MHz and second filter 855 would have a passband of approximately 400-600 MHz.

Switches 852 and 856 are preferably semiconductor devices with one common connection and a plurality of other connections to which the common connection can couple, according to a code sent to the switch. Multiple switching devices may be cascaded to implement the switching diversity required to select the appropriate filter. These switches are preferably controlled using a computing device such as microcontroller 826 located in the tap. This computing device coordinates both the frequency selection of oscillator 851 and the configuration of switches 852 and 856. Although switches 852 and 856 are preferably semiconductor devices for reasons of cost and simplicity, electro-mechanical switches may also be used and are within the scope of the invention.

The output from switch 856 is preferably coupled to directional coupler 835 which injects upstream transmissions from modems at an appropriate level onto bidirectional signal path 825 which couples these signals upstream to the Node.

In the example shown in FIGS. 8a and 8b, there are three possible upstream transmission channels available in the network, labelled X, Y and Z, each approximately 200 MHz wide. Modem upstream transmission 871 is shown being translated to upstream channel Y 876 which is inserted into upstream channel group 879 between 200 and 400 MHZ. Channel group 879 in combination with downstream channel group 878 form the overall spectrum 877 of the network facilitated by FMA-taps.

The advantage of this aspect of the present invention is that it allows the available upstream bandwidth of the overall network to be multiplied several times without needing to upgrade customer modems.

From another perspective, the present invention provides a signal modulation scheme for an HFC network comprising two or more upstream channels grouped adjacent to each other at low frequency and two or more downstream channels grouped adjacent to each other at high frequency wherein each upstream and downstream channel has the same signal bandwidth as the maximum transmission bandwidth of customer modems coupled to the network.

When attempting to increase the operating bandwidth of an HFC network using frequency multiplexing techniques, it seems useful to maintain the existing arrangement of transmission bands on the network and add additional transmit and receive bands at higher frequencies. This approach maximises compatibility with legacy services and eases deployment processes.

The problem with this approach is that the filtering required to separate multiple interleaved transmit/receive signals spread across a wide frequency range is complex and costly and the performance of these filters is inferior to comparable low frequency filters. Hence, network performance will be compromised.

The ‘Q’ of a filter is a measure of filter performance and is related to the pass-band bandwidth of the filter compared to the centre frequency and to the steepness of filter cut-off. Filters with high Q have steep cut-off characteristics and are able to separate signals more effectively in the frequency domain, thereby achieving more efficient utilisation of available network spectrum. However, high Q filters are generally difficult and expensive to make and it is desirable not to use a higher Q than is needed in the intended application.

If a signal spectrum is shaped by a high frequency filter with a particular Q and band edge steepness, when this spectrum is translated down in frequency, the steepness of the spectrum edges does not change, but the centre frequency of the spectrum is lower. This effectively means that the Q of the filter is reduced by the translation process, and a high frequency bandpass filter is more wasteful of low frequency signal spectrum when translated down by a mixer. Therefore, the inventor has realised there is a considerable advantage in positioning the narrowest bandwidth channels, i.e., upstream channels, at the lowest possible frequency where reduction in Q as a result of frequency translation is minimised and filters are relatively easy to manufacture and have the lowest possible cost. This implies that it is advantageous to group upstream channels separately from downstream channels in a frequency multiplexed HFC network, with upstream channels placed at the lowest possible frequency. Although this arrangement of channels complicates network upgrade procedures, the inventor believes it provides superior overall network performance.

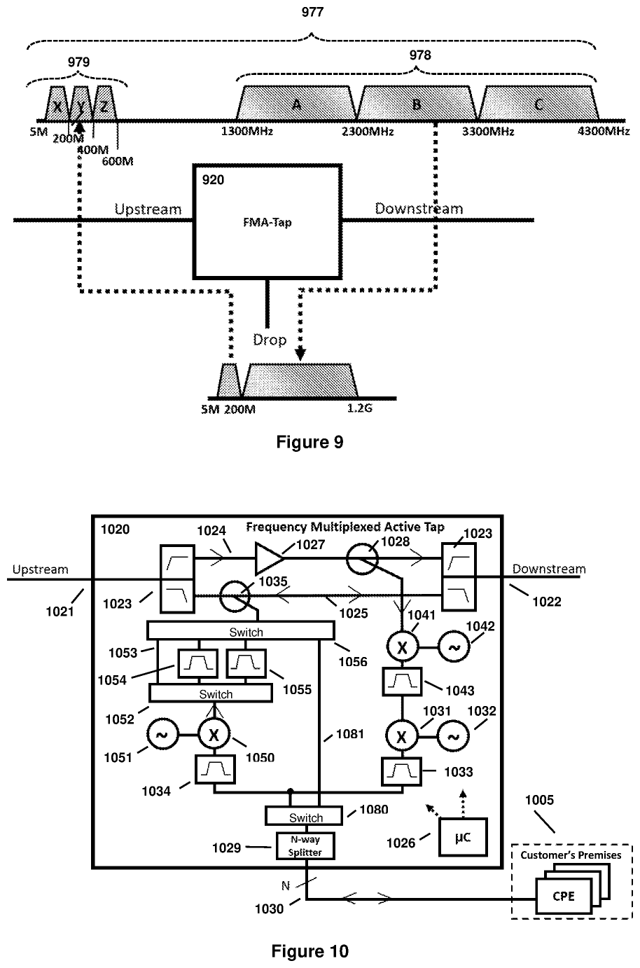

### The Embodiments of FIG. 9

FIG. 9 shows an example of a preferred arrangement of upstream and downstream channels according to a preferred embodiment of the present invention. Upstream channels X, Y and Z are clustered at the lowest end of the overall transmission spectrum 979 and downstream channels A, B and C are clustered at the top end of the spectrum 978. Preferably the bandwidth of each upstream channel is equal to the maximum transmission bandwidth available from customer modems and contains a DOCSIS modulated signal. For example, this bandwidth may be 200 MHz. FIG. 9 provides an example of three adjoining upstream channels X, Y and Z but the present invention is not limited to this number of channels. Optionally, network operators may choose to leave dead-bands between each of these upstream bands if this improves network performance. Downstream transmission channels 978 are also preferably chosen to have bandwidths equal to the receive bandwidth of customer modems and contain DOCSIS modulated signals.

From another perspective, the present invention provides an FMA-Tap comprising circuitry which allows the tap to work in a legacy-compatible-mode either during network upgrade or during network outages.

Although there are many advantages provided by FMA-Taps, upgrading an existing network to use these taps is potentially challenging.

Because the enhanced transmission characteristics of an FMA-Tap is likely to be incompatible with the legacy network into which it is being installed, the network segment could potentially be out of service until all taps on the network segment are upgraded to the new transmission standard. Disruption of customer services for perhaps days or weeks while an upgrade is performed is unacceptable for network customers.

Also, as noted above, a spectrum allocation plan which preserves both upstream and downstream legacy traffic in the lowest frequency band would solve this spectrum compatibility problem, but is not desirable because this choice makes system design complex and costly.

The present invention overcomes these difficulties by comprising circuitry which allows the FMA-tap to work in legacy-mode immediately after installation and then allows the tap to be electronically reconfigured at a later stage to a new enhanced mode of operation using commands sent to the tap from a remote site. In this way, network disruption caused by upgrading taps is minimised.

A preferred embodiment of the present invention provides an FMA-tap comprising:
A through signal path partitioned into an upper frequency path and a bidirectional lower frequency signal path,
a directional coupler which couples signals to and from said lower frequency signal path,
a plurality of switches coupled to said directional coupler which select one of a plurality of independent signal paths which is coupled to the tap drop port, wherein:
   at least one of said plurality of selectable signal paths comprises a mixer which can translate signals to different frequencies, and
   one of said plurality of selectable signal paths comprises a bidirectional signal path which is not coupled to said mixer and which has a signal bandwidth equal to the total bandwidth of said lower frequency through signal path.

### The Embodiments of FIG. 10

FIG. 10 provides an example of a preferred embodiment of the present invention. FMA tap 1020 receives N upstream signals from modems 1005 coupled to drop port 1030. These N upstream signals are combined in splitter/combiner 1029 to form a composite upstream signal.

In the enhanced mode of operation of the tap, switch 1080 directs the composite upstream signal to filter 1034. The composite signal is then coupled through filter 1034 and through mixer 1050. According to the configuration of switch 1052 and switch 1056, the upstream signal is coupled to one of a plurality of independent paths provided by direct connection 1053 and filters 1054 and 1055. As described above, these components allow the combined upstream signal to be filtered and injected into the tap's upstream signal path 1025.

When an FMA tap is installed into a legacy network, it is able to operate in a different mode which is compatible with the existing spectrum allocation of the network. In order to implement this mode of operation, the present invention couples bidirectional legacy signals between drop port 1030 and bidirectional upstream/downstream signal path 1025 without altering their characteristics.

To activate this legacy mode of operation, switches 1080 and 1056 select path 1081 which is unaffected by any frequency translation and allows bidirectional signal flow across the entire bandwidth of the lower frequency signal path 1025 of the tap. These switches are preferably semiconductor devices which are controlled using a computing device such as microcontroller 1026 contained within the tap. They may also be electro-mechanical switches.

The settings for these switches preferably have a default setting which places the tap in legacy mode when initially installed or when a network outage occurs. Commands to change the operation mode of the tap are preferably sent to the computing device 1026 over the network from a remote location. This device 1026 is preferably programmed to also make autonomous decisions to select tap operation mode depending on the current status of the network.

When the network segment is completely upgraded and capable of utilising the enhanced bandwidth provided by the FMA taps, signal path 1081 also provides a fall-back ‘safe mode’ of operation for the network. In this ‘safe mode’, the number of active devices in the signal path is minimised, making the network relatively insensitive to device failures. Although this fall-back path is more robust, it only provides a fraction of the enhanced network bandwidth, for example one third. However, this level of network performance is able to provide customers with a useable service in the time it takes the network to be repaired.

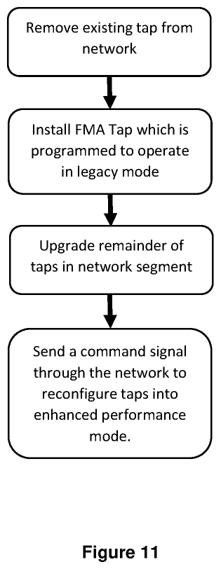

### The Embodiments of FIG. 11

From another perspective the present invention therefore provides a method of progressively upgrading an HFC network comprising the steps of:
1. Removing a tap from an existing network.
2. Installing an FMA tap comprising switches which can select either an enhanced mode of operation or a legacy-compatible mode of operation and which are configured to select the legacy mode of operation,
3. Upgrading the remainder of the taps on the network in a similar manner,
4. Sending a command signal to each FMA tap through the upgraded network segment which causes them to switch from legacy mode to enhanced mode.

FIG. 11 summarises the above method.

Typically taps in existing networks have detachable face plates which allow drop connectors and internal componentry to be replaced without needing to re-terminate hardline connections on the upstream and downstream ports. This feature facilitates the removal and replacement of tap circuitry.

From yet another perspective, the present invention provides a Frequency Multiplexed Active Tap comprising amplifiers which increase the amplitude of downstream signals passed to the tap's drop ports.

In existing HFC networks, it is often necessary to install amplifiers in customer's premises to make up for excessive signal attenuation. This attenuation can be caused by unusually long drop cables leading from the tap into the premises, or by customer requirements for in-premises splitters needed to distribute signals to multiple devices or locations within the premises. In networks which use higher frequencies, additional gain is needed in the network to counteract increased signal loss at these higher frequencies.

When network operators upgrade an existing network, it is often necessary to upgrade amplifiers installed in customer premises, which represents a significant cost. To address this, the present invention comprises an FMA-tap with integrated amplifiers which boost downstream signals and provide frequency dependent equalisation where required, at minimal cost.

A preferred embodiment of the present invention provides an FMA-tap comprising:
A through signal path partitioned into a unidirectional upper frequency path and a bidirectional lower frequency path
A directional coupler arranged to couple a downstream signal from said upper frequency signal path,
A plurality of mixers and filters coupled to said directional coupler which translate a portion of the downstream signal to a different frequency band
At least one amplifier, coupled to said plurality of mixers and filters, which amplifies the translated portions of the downstream signal and couples this signal to the drop port of the tap.

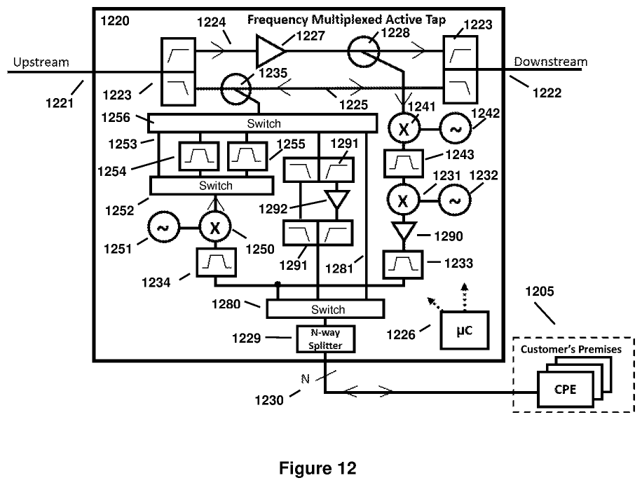

### The Embodiments of FIG. 12

FIG. 12 shows one example of a preferred embodiment of the present invention. Diplexers 1223 are used to split the through signal of FMA tap 1220 into an upper frequency signal path 1224 and a lower frequency signal path 1225. When the FMA tap is operating at maximum capacity, downstream signals are preferably contained in upper frequency signal path 1224 and are demodulated down to the receiving band of customer modems 1205 by mixers 1241 and 1231. Amplifier 1290 then provides amplification for this signal to compensate for losses of the drop cable coupled to the tap, or additional losses within the customer's premises. Amplifier 1290 may provide frequency dependent gain (i.e., equalisation) and may include a filter at its input to restrict gain to frequencies within receive bandwidth of customer modems.

From yet another perspective, the present invention provides a frequency multiplexed active tap comprising:
A unidirectional upper frequency signal path and a bidirectional lower frequency signal path
An amplifier which couples downstream signals from said lower frequency signal path to said drop port
wherein said amplifier's operational bandwidth is within the receiving bandwidth of customer modems coupled to said drop port.

Because HFC networks are often decades old, it is likely that the maximum operating bandwidth of the network, including amplifiers and taps, is significantly less than the potential operating bandwidth of customer modems, which have been installed into the network in more recent times. For example, a modern modem may have a potentially available upstream transmit band of 5-200 MHz whereas the network might only support 5-65 MHz upstream transmission.

When an FMA tap is installed in the network to increase network capacity, it is important that any elements of the legacy network which limit performance are removed. For example, amplifiers which are installed in customer premises to overcome excess drop cable loss or splitter loss are likely to limit the performance of the upgraded network and need to be removed. It is commercially advantageous to remove these amplifiers at the same time as field technicians are upgrading the network to use FMA taps to minimise deployment cost and time.

To address this issue, the present invention provides amplification for drop port signals when the FMA tap is working in its enhanced mode of operation. This means there is no need for amplifiers in customer premises and existing amplifiers can be removed.

However, a problem arises during network upgrade. If premises amplifiers are preferably removed when FMA taps are being installed, there is potentially insufficient signal amplitude available for customer modems until the whole network segment is upgraded and switched over to its enhanced mode of operation.

Therefore, there is a need for an FMA tap to work in a legacy mode after installation which temporarily provides downstream amplification for drop signals before the enhanced mode of operation is enabled.

Referring to FIG. 12, a preferred embodiment of the present invention comprises FMA tap 1220 with directional coupler 1235 coupled to bidirectional lower frequency signal path 1225 and to selector switch 1256. Amplifier 1292 is coupled to diplexers 1291 which separate upstream and downstream components of bidirectional signals from signal path 1225. Amplifier 1292 amplifies downstream signals to provide adequate signal levels to modems when tap 1220 is operating in legacy mode prior to being enabled to work in enhanced performance mode. Selector switch 1256 selects the signal path through amplifier 1292 when legacy mode gain is required.

Amplifying device 1292 preferably comprises flat or frequency dependent pre-equalisation or post-equalisation of the drop signal to correct for cable loss. For example, amplifier 1292 may pre-equalise the signal by boosting high frequency components of the signal to compensate for the cable loss of the drop cable between the tap and the customer modem. Amplifier 1292 may also be configured to provide additional flat gain across the signal bandwidth to account for flat loss, for example created by splitters used in the customer's premises. These gain settings may either be programmed using static switches or modules plugged into the tap at time of installation or may be electronically programmed using a device such as a microcontroller 1226 which receives configuration data sent from a remote site.

As noted above, while this invention has been described in connection with specific embodiments thereof, it will be understood that it is capable of further modification(s). This application is intended to cover any variations, uses or adaptations of the invention following in general, the principles of the invention and including such departures from the present disclosure as come within known or customary practice within the art to which the invention pertains and as may be applied to the essential features hereinbefore set forth.

“Coupled” when used in this specification is taken to specify the presence an electrical connection between two or more circuit elements either by direct connection or by indirect connection through intermediate elements.

The following sections I-VII provide a guide to interpreting the present specification.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology Are Not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™, Pentium II™, Xeon™, Celeron™, Pentium Pro™, Efficeon™, Athlon™, AMD™ and the like), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

I claim:

1.-63. (canceled)

64. A tap for use in a coaxial distribution network, the tap comprising:
an upstream port, a downstream port, and at least one drop port; and
a plurality of signal paths coupled between the upstream port and the downstream port, each signal path having a passband frequency range which is not common to any other signal path.

65. A tap as claimed in claim 64, in which the plurality of signal paths comprises one or a combination of:
a unidirectional, high frequency signal path; and a bidirectional, low frequency signal path, and;
at least one diplexer.

66. A tap as claimed in claim 65, in which the unidirectional, high frequency, signal path is one or a combination of:
a downstream path, and;
coupled to the tap drop port using a directional coupler.

67. A tap as claimed in claim 65, including an amplifier comprises an equaliser to provide different amplification at different frequencies and in which the high frequency signal path comprises amplifier to amplify downstream signals.

68. A tap as claimed in claim 67, further comprising a computing device to control the characteristics of the equaliser and, in which the computing device is configurable to receive data from a remote site and to use that data to control the characteristics of the equaliser autonomously using a program stored in the computing device.

69. A tap as claimed in claim 64, the tap further comprising:
a first mixer having an input port and an output port, the first mixer being configured to translate signals received at its input port into signals which are in a different frequency range at its output port; and
a first filter,
in which:
downstream signals are receivable by the tap at the upstream port;
the downstream signals are coupled to the input of the first mixer; and
the output of the first mixer is coupled to the input of the first filter, and;
in which:
signals coupled between the upstream and downstream ports of the tap are conveyed by independent, high frequency and low frequency signal paths; and
the lowest frequency conveyed by the high frequency signal path is higher than the highest frequency able to be received by the CPE transceiver.

70. A tap as claimed in claim 69, the tap further comprising, interposed between the outport port of the first filter and the drop port:
a second mixer having an input port and an output port, the second mixer being configured to translate signals received at its input port into signals which are in a different frequency range at its output port; and
a second filter,
in which:
signals from the output port of the first filter are receivable at the input port of the second mixer; and
signals from the output port of the second mixer are receivable at the input port of the second filter;
where the tap is characterised by one or a combination of:
the output of the first filter is coupled to the at least one drop port of the tap;
the output of the second filter is coupled to the at least one drop port of the tap, and;
the downstream signals are coupled to the input of the first mixer by a directional coupler, and;
in which:
signals coupled between the upstream and downstream ports of the tap are conveyed by independent, high frequency and low frequency signal paths; and
the lowest frequency conveyed by the high frequency signal path is higher than the highest frequency able to be received by the CPE transceiver.

71. A tap as claimed in claim 69, coupled to a customer's premises equipment transceiver (CPE transceiver), the first filter having a passband frequency range which is within the frequency range of the CPE transceiver.

72. A tap as claimed in claim 70, coupled to a customer's premises equipment transceiver (CPE transceiver), the second filter having a passband frequency range which is within the frequency range of the CPE transceiver.

73. A tap as claimed in claim 69, in which the first filter has a passband frequency range which selects a portion of the upper sideband signal which is produced by the first mixer.

74. A tap as claimed in claim 70, the tap coupled to a CPE transceiver, in which the second filter has a passband frequency range which is within the receiving frequency range of the CPE transceiver.

75. A tap as claimed in claim 64, in which:
CPE-generated upstream signals are received by the tap at its drop ports,
the received upstream signals are coupled to a mixer which is configured to either translate these signals to a different frequency range, or leave the signals in their existing frequency range;
the mixer is coupled to an oscillator and a first switch;
the first switch is coupled to a plurality of filters;
the plurality of filters are coupled to a second switch;
the second switch is coupled to a directional coupler;
the directional coupler is coupled to the upstream port of the tap, and
the first and second switches select a signal path for upstream signals through one of the plurality of filters.

76. A tap as claimed in claim 75, characterised by one or a combination of:
the signal path for upstream signals through one of the plurality of filters comprises a filter which selects the lower sideband signal which is produced by the mixer;
the plurality of filters comprises filters which have passband bandwidths of at least the maximum bandwidth of upstream transmissions which are to be received on the drop port;
the oscillator frequency and the first and second switches are controlled by a computing device in which the computing device is contained within the tap and is configured to receive data from a remote site and to use that data to control at least one of:
the oscillator frequency;
the state of the first switch; and
the state of the second switch.

77. A tap for use in a coaxial distribution network, the tap comprising an upstream port, a downstream port, a plurality of drop ports, at least one unidirectional frequency-translating signal path and a plurality of switches, in which tap:
the drop ports are available to be coupled to one or more CPEs;
signals are coupled between the upstream port and downstream port using a high frequency unidirectional signal path and a low frequency bidirectional signal path;
the low frequency bidirectional signal path has a passband frequency range which includes the highest and lowest frequencies able to be received or transmitted by the CPEs; and
the plurality of switches are configurable either to select a signal path which translates the frequency of upstream signals coupled from the drop port to the low frequency, bidirectional signal path, or to bypass this upstream frequency translating signal path, thereby providing bidirectional signal flow from the drop ports to the low frequency bidirectional signal path.

78. A tap as claimed in claim 77, characterised by one or a combination of:
at least one of the plurality switches is controllable by a computing device which is contained within the tap;
the computing device is configurable to receive data from a remote site and to use that data to change the state of at least one of the plurality of switches;
the tap further comprises a plurality of switches which are configurable to couple downstream signals which are conveyed by the low frequency bidirectional signal path to an amplifier which increases the amplitude of downstream signals passing from the bidirectional signal path to at least one of the drop ports.

79. A tap suited for use in a coaxial distribution network comprising an upstream port, a downstream port and a plurality of drop ports wherein:
signals coupled between said upstream and downstream ports of the tap are conveyed by a plurality of signal paths which have different passband frequency ranges.

80. A tap according to claim 79, comprising:
a high frequency signal path and a low frequency signal path wherein:
said high frequency signal path is unidirectional; and
said low frequency signal path is bidirectional;
wherein said high frequency signal path comprises an amplifier which increases the amplitude of downstream signals;
wherein said amplifier comprises an equaliser which provides different amplification and different frequencies;
wherein the characteristics of said equaliser are controlled by a computing device contained within said tap;
wherein said computing device is configured to receive data from a remote site and to use this data to change said equaliser characteristics.

81. A tap suited for use in coaxial distribution networks comprising an upstream port, a downstream port, a plurality of drop ports and a plurality of switches wherein:
said drop ports are available to be coupled to one or more CPEs;
signals are coupled between said upstream port and downstream port using a high frequency unidirectional signal path and a low frequency bidirectional signal path;
said low frequency bidirectional signal path has a passband frequency range which includes the highest and lowest frequencies able to be received or transmitted by said CPEs;
said plurality of switches are able to be configured to couple said low frequency bidirectional signal path to said drop ports.

82. A tap according to claim 81, wherein said plurality of switches are controlled by a computing device contained within said tap.

83. A tap according to claim 82, wherein said computing device is configured to receive data from a remote site and to use this data to change the state of said plurality of switches.
